(19) United States
(12) Patent Application Publication
(10) Pub. No.: US 2026/0176968 A1
(43) Pub. Date: Jun. 25, 2026

(54) SYSTEM FOR IN SITU RESOURCE UTILIZATION IN EXTRATERRESTRIAL ENVIRONMENTS

(71) Applicant: Honeybee Robotics, LLC, Longmont, CO (US)

(72) Inventors: Nicklaus Traeden, Cuyahoga Falls, OH (US); Kathryn Faye Bywaters, Monrovia, CA (US); Zachary Fitzgerald, Sunland, CA (US); Joseph Palmowski, Lithia, FL (US); Leo Stolov, Pasadena, CA (US); Robert Kenneth Van Ness, JR., Pasadena, CA (US); Kris Zacny, Altadena, CA (US)

(21) Appl. No.: 19/537,292

(22) Filed: Feb. 11, 2026

Related U.S. Application Data
(63) Continuation of application No. 19/185,084, filed on Apr. 21, 2025.
(60) Provisional application No. 63/637,203, filed on Apr. 22, 2024.

(51) Int. Cl. E21C 51/00; B64G 1/22; B64G 4/00; E21C 37/12

(52) U.S. Cl. CPC E21C 51/00; B64G 1/2225; B64G 4/00; E21C 37/12

(57) ABSTRACT

Systems and methods for the in situ extraction of materials, for example lunar regolith, from a celestial body. The systems and methods described herein can be used in outer space or on Earth. A high pressure gas is delivered to loosen up the material and form a borehole. A deployable mast deploys from a stowed, coiled configuration to a linear, deployed configuration into the borehole. A deployable tube may deploy to assist with delivering the gas and/or collecting the loosened material. One or more jets emit the gas. The jets may be supported at a free end of the tube or mast. The jets may direct loosened material through the tube and/or mast toward a collection reservoir. A flow separator may filter the loosened material from the gasses.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. For example, this application is a continuation of U.S. application Ser. No. 19/185084, filed Apr. 21, 2025, titled SYSTEM FOR IN SITU RESOURCE UTILIZATION IN EXTRATERRESTRIAL ENVIRONMENTS, which claims the benefit of U.S. Provisional Application No. 63/637203, filed on Apr. 22, 2024, titled SYSTEM FOR IN SITU RESOURCE UTILIZATION IN EXTRATERRESTRIAL ENVIRONMENTS, the entire content of each of which is incorporated by reference herein and forms a part of this specification for all purposes.

### BACKGROUND

### Field

The disclosure relates generally to systems and methods for the in situ extraction of resources or material, such as lunar regolith or soil, from extraterrestrial environments, like the moon.

### Description of the Related Art

Traditional methods of collecting lunar regolith depend on the use of rovers and scoops. These traditional methods can require a large amount of time to collect the lunar regolith.

### SUMMARY

The embodiments disclosed herein each have several aspects, no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing systems and methods for the collection of materials.

The following disclosure describes non-limiting examples of some embodiments. For instance, other embodiments of the disclosed systems and methods may or may not include the features described herein. Moreover, disclosed advantages and benefits may apply only to certain embodiments of the invention and should not be used to limit the disclosure.

Systems and methods for the in situ extraction of materials, for example lunar regolith, are described. The systems and methods described herein can be used in outer space or on Earth. An example system includes a deployable tube for directing, delivering, or applying a high pressure gas to form a borehole and a deployable mast that can deploy from a stowed configuration into the borehole. The system includes a plurality of jets for directing, delivering, or applying material through a channel of the deployable mast and into a reservoir. An example method includes forming a borehole using a high pressure gas, deploying a mast into the borehole, and removing material by transporting the material through a channel of the deployed mast.

In one aspect, a system for in situ extraction of a material includes a deployable tube, a deployable mast, and a plurality of jets. The deployable tube directs a high pressure gas into the material to form a borehole and break up the material into smaller pieces of material. The deployable mast deploys into the borehole from a stowed configuration to a deployed configuration. The plurality of jets is supported at a free end of the deployable tube or a free end of the deployable mast. The plurality of jets directs the smaller pieces of material through a channel of the deployable mast and into a reservoir.

Various embodiments of the various aspects may be implemented. In some embodiments, the system includes a skirt configured to surround the deployable mast on a surface of the material. The skirt includes an opening defining an area for formation of the borehole. In some embodiments, the material is lunar regolith. In some embodiments, the deployable tube and the deployable mast deploy simultaneously. In some embodiments, wherein the plurality of jets are coupled with the free end of the deployable mast. In some embodiments, the system includes a collection tube coupling the deployable mast and the reservoir. The plurality of jets direct the smaller pieces of material through the collection tube and into the reservoir. In some embodiments, the deployable tube is a metal tube. The metal tube is stowed in a coiled configuration. In some embodiments, the system is coupled to a lander. In some embodiments, the deployable mast includes an elongate band configured to deploy from a coiled shape in the stowed configuration to the deployed configuration. In some embodiments, the deployable tube is coupled to the deployable mast.

In another aspect, a method for in situ extraction of a material includes delivering a high pressure gas into the material to break up the material into smaller pieces of material and form a borehole. The method also includes deploying a mast from a stowed configuration to a deployed configuration, the mast being deployed into the borehole. The method also includes directing the smaller pieces of material through a channel of the mast and into a reservoir.

Various embodiments of the various aspects may be implemented. In some embodiments, directing the smaller pieces of material through the channel of the mast includes directing gas from one or more jets supported at a free end of the mast. In some embodiments, the method includes delivering the high pressure gas through an opening of a skirt located on a surface of the material. In some embodiments, the method includes deploying a metal tube downward toward the material and directing the high pressure gas through the metal tube. In some embodiments, a free end of the metal tube is coupled with a free end of the mast. In some embodiments, the material is lunar regolith. In some embodiments, the borehole comprises a depth of at least 1 meter. In some embodiments, the borehole comprises a diameter of at least 100 mm. In some embodiments, deploying the mast includes feeding an elongate band from a coiled shape in the stowed configuration to helical, longitudinal shape in the deployed configuration. In some embodiments, delivering the high pressure gas and deploying the mast occur simultaneously.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawing, may be arranged, substituted, combined, and designed in a wide variety of different configurations, all of which are explicitly contemplated and make part of this disclosure.

FIG. 1A is a schematic illustration of an example system for in situ extraction of material in a stowed configuration;

FIG. 1B is a schematic illustration of the system for in situ extraction of material of FIG. 1A in a deployed configuration;

FIG. 2A is a perspective view of an example deployable tube from the system of FIGS. 1A and 1B for providing high pressure gas to form a borehole;

FIG. 2B is a perspective view of an example excavation assembly for deploying the deployable tube of FIG. 2A and forming a borehole;

FIG. 2C is a side view of another example excavation assembly for deploying a gas tube for a jet through the deployable tube of FIG. 2A and forming a borehole;

FIG. 3 is an example deployment system for a deployable mast that may be used with the systems of FIGS. 1A-2B;

FIG. 4 is a flow chart illustrating an example method for in situ extraction of material that may be used with the systems of FIGS. 1A-3;

FIG. 5A is a perspective view of another example system for in situ extraction of material in a deployed configuration;

FIG. 5B is a cross-sectional side view of the example system of FIG. 5A in a stowed configuration;

FIG. 5C is a partial cross-sectional perspective view of an end of the deployable tube showing a jet assembly and skirt of the system of FIGS. 5A and 5B;

FIG. 6A is a side view of another example of a linearly deployable tube from a coiled configuration for use with the system for in situ extraction of material shown in a deployed configuration;

FIGS. 6B and 6C are perspective views of an end of the deployable tube having a jet assembly of the system of FIG. 6A;

FIG. 6D is a sideview of the jet assembly of FIGS. 6B and 6C; and

FIG. 7 is a cross-sectional side view of an example flow separator for separating high pressure gas and the extracted material.

### DETAILED DESCRIPTION

The following detailed description is directed to certain specific embodiments related to systems and methods for the in situ extraction of resources, such as lunar regolith. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments. Reference will now be made in detail to embodiments of the invention, examples of which are illustrated in the accompanying drawings. Wherever possible, the same reference numbers will be used throughout the drawings to refer to the same or like parts.

The disclosure relates generally to systems and methods for the in situ extraction of resources or material. The systems and methods may be described with specific reference to the extraction of lunar regolith but can also be used for the extraction of materials such as soil on Earth. In situ resource utilization (ISRU) of lunar regolith is useful for a number of construction and development tasks needed to achieve lunar permanence. Many traditional methods rely on rovers to gather material from the surface and bring it back to a lander or hub. Bucket arms in these traditional methods may be used to load the gathered material into a processing structure. The use of rovers and bucket arms in traditional methods for collection of sufficient quantities of material may take a large portion of the approximately two week long lunar day. The methods and systems described herein are advantageous over these and other existing systems and methods, as the systems and methods according to the present disclosure may be used for rapidly acquiring large volumes of lunar regolith, among other advantages.

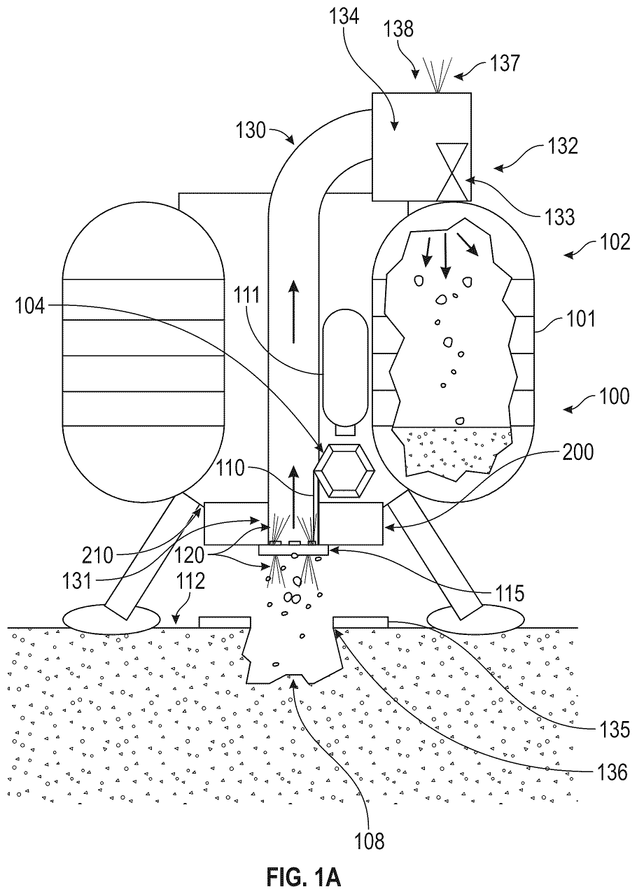

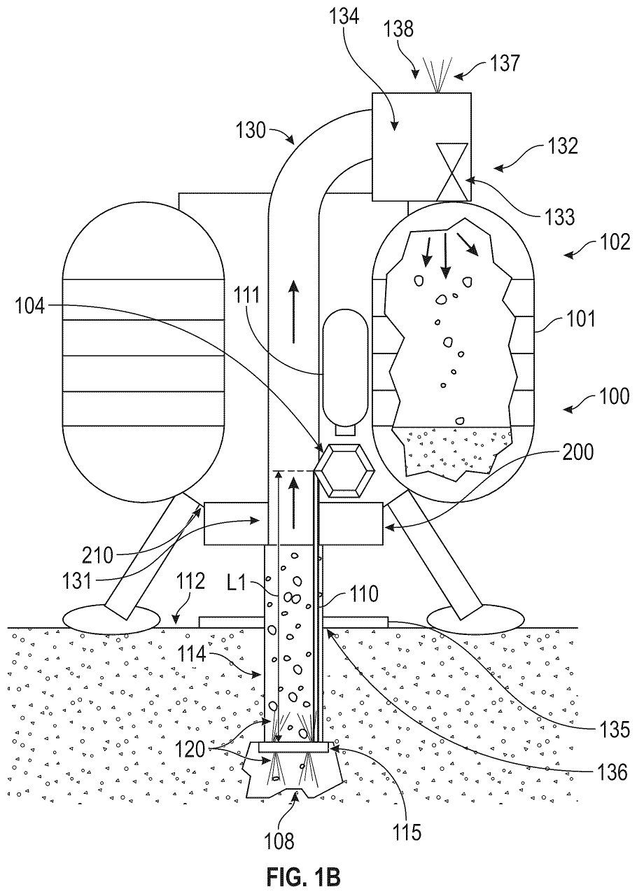

FIGS. 1A and 1B are schematic illustrations of a system 100 for in situ extraction of resources or material, for example lunar regolith. FIG. 1A illustrates the system 100 in a stowed configuration. FIG. 1B illustrates the system 100 in a deployed configuration. In some embodiments, the system 100 may be coupled with a lander 102. The system 100 may be in a stowed configuration as in FIG. 1A for transportation to space or the location where the system 100 will be used as in FIG. 1B. The system 100 may be a pneumatic downhole system used to rapidly excavate a borehole and collect regolith into a reservoir 101 on the lander 102.

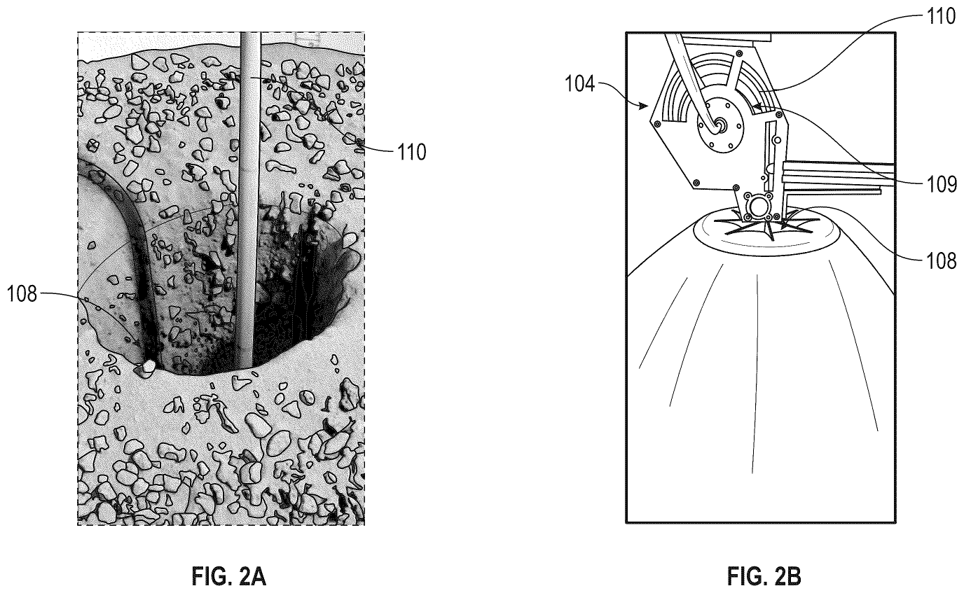

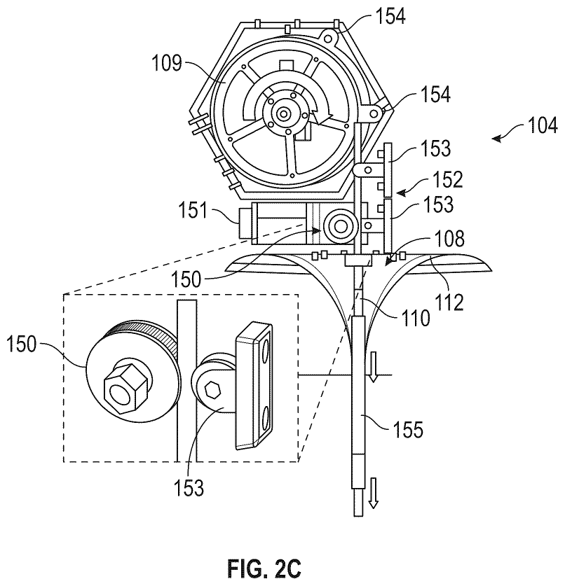

The system 100 may include an excavation assembly 104. FIGS. 2B and 2C illustrate the excavation assembly 104 removed from the lander 102. The excavation assembly 104 may be used to form a borehole 108. The excavation assembly 104 may include a deployable tube 110. In some embodiments, the excavation assembly 104 may include more than one deployable tube 110. A free end of the deployable tube 110 may advance downward to the surface 112. FIG. 2A illustrates a portion of the deployable tube 110 in the borehole 108. The deployable tube 110 may be a metal tube. The deployable tube 110 may passively deploy in response to deployment of a deployable mast 114, as described herein. In some examples, the deployable tube 110 may deploy similarly as described with respect to the deployable mast from a coiled (e.g., wound) stowed configuration to a deployed linear configuration. As shown in FIG. 2B, the deployable tube 110 may be stowed in a coil configuration and deploy into a linear configuration. The deployable tube 110 may be stowed about a reel 109. As the deployable tube 110 deploys, a length L1 (see FIGS. 1A and 1B) of the deployable tube 110 may increase. In some embodiments, the deployable tube 110 may deploy into an unretractable deployed configuration. In some embodiments, the deployable tube 110 may be retractable following deployment to the stowed configuration.

As shown in FIG. 2C, the excavation assembly 104 may include a drive roller assembly 150. The drive roller assembly 150 may include a drive roller and a drive counter roller. The drive roller assembly 150 may engage the deployable tube 110 when in a stowed or coiled configuration. The excavation assembly 104 may include an actuator 151 to rotate the drive roller assembly 150 and pull the deployable tube 110 from the stowed or coiled configuration.

The excavation assembly 104 may include a straightener assembly 152. The straightener assembly 152 may include the drive roller assembly 150 and one or more additional rollers 153. The straightener assembly 152 may assist in straightening the deployable tube 110 from the stowed or coiled configuration to the deployed configuration. The excavation assembly 104 may include one or more guides 154. The one or more guides 154 may assist in guiding the stowed deployable tube 110 to the straightener assembly 152. The excavation assembly 104 may include a deployable tip bushing 155. The deployable tip bushing 155 can provide a boundary that assists in straightening the deployable tube 110. The deployable tip bushing 155 can be positioned downstream the straightener assembly 152.

The deployable tube 110 may direct, apply, and/or deliver a high pressure gas into a surface 112 to form the borehole 108. The deployable tube 110 may be coupled with a gas storage tank or gas supply 111. The gas supply 111 may be coupled to the lander 102. The surface 112 may be a land surface or ground surface on Earth or another celestial body, such as the moon, Mars, etc. The surface 112 may include raw materials. Example raw materials include but are not limited to lunar regolith, frozen water, minerals, ore, metallic ores, soils, rocks, and water ice. The high pressure gas may break up the material as the high pressure gas contacts the surface 112. The high pressure gas may be activated as the deployable tube 110 is deployed. In some embodiments, the deployable tube 110 may pause or stop deploying prior to activation of the high pressure gas. The excavation assembly 104 may rapidly excavate the borehole 108.

The excavation assembly 104 may be used to excavate or form boreholes 108 of any depth and diameter. The depth and diameter of the boreholes 108 may be dependent upon the amount or volume of material to be collected. A depth of the borehole 108 may be at least 1 meter, at least 2 meters, at least 3 meters, at least 4 meters, at least 5 meters, at least 6 meters, or more. A diameter of the borehole 108 may be at least 70 mm, at least 80 mm, at least 90 mm, at least 100 mm, at least 110 mm, at least 120 mm, at least 130 mm, or more. There may be a balance between a pneumatic force at the drill or excavation area and a drill depth. In one non-limiting example a 152.4 mm (6 inch) borehole may drill or excavate 14 meter deep below the surface 112 to collect 1 meter 3 (min 1100 kg depending on regolith density) of material, whereas to collect the same volume a 203.2 mm (8 inch) bore may only need to drill or excavate 8 meters deep.

The system 100 may include a deployable mast 114. The deployable mast 114 may deploy into the borehole 108 from a stowed configuration to a deployed configuration. The deployment of the deployable mast 114 and the excavation of the borehole 108 may occur simultaneously. The deployable mast 114 may include any of the features of any of the deployable masts and/or utilize any features of the methods of deployment of such masts as described in U.S. application Ser. No. 19/092785, titled SYSTEMS AND METHODS FOR WELDED DEPLOYABLE LINEAR STRUCTURES, filed on Mar. 27, 2025, U.S. application Ser. No. 19/093044, titled SYSTEMS AND METHODS FOR DEPLOYABLE LINEAR STRUCTURES WITH DOUBLERS, filed on Mar. 27, 2025, U.S. application Ser. No. 19/092758, titled SYSTEMS AND METHODS FOR SPACE HABITATS USING DEPLOYABLE LINEAR STRUCTURES, filed on Mar. 27, 2025, U.S. application Ser. No. 19/092767, titled SYSTEMS AND METHODS FOR DEPLOYABLE LINEAR STRUCTURES WITH RIVETS, filed on Mar. 27, 2025, U.S Provisional Application No. 63/701002, titled SYSTEMS AND METHODS FOR DEPLOYABLE LINEAR STRUCTURES WITH WELDING, DOUBLERS, AND/OR RIVETS, filed Sep. 30, 2024, and U.S. Provisional Application No. 63/57142, titled DEPLOYABLE INTERLOCKING ACTUATED BANDS FOR LINEAR OPERATIONS, filed Mar. 28, 2024, the entirety of each of which is incorporated by reference herein for all purposes and forms a part of this specification.

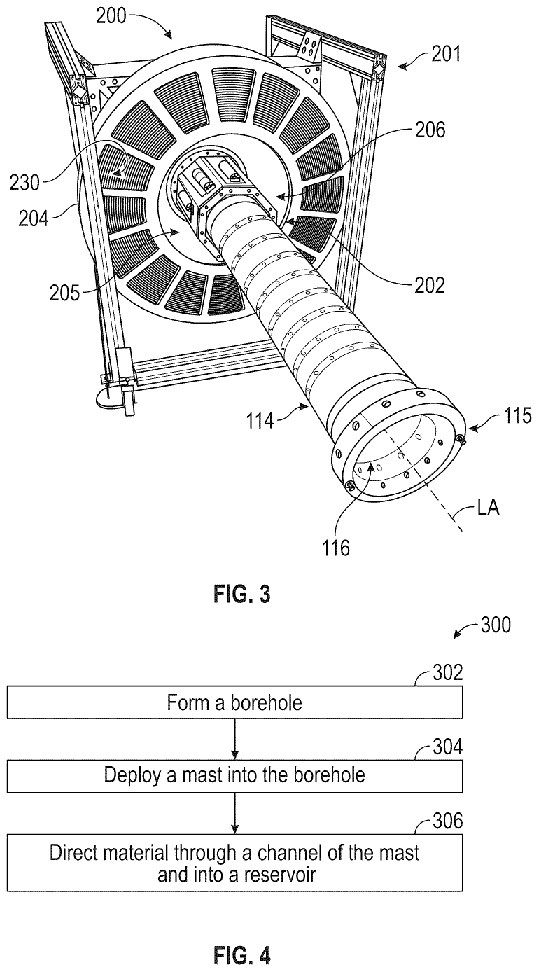

In some embodiments, any of the deployable masts described herein (e.g., deployable mast 114, deployable mast 414, deployable mast 514) may be deployed using a deployment system 200, for example as shown in FIG. 3. Deployable mast 114 will be used for illustrative purposes but the disclosure may apply to any deployable mast. The deployment system 200 may be coupled to the lander 102 shown in FIGS. 1A and 1B. FIG. 3 illustrates an embodiment of the deployment system 200 including the deployable mast 114 extending from the deployment system 200. The deployable mast 114 is shown in a deployed configuration. The deployable mast 114 may be deployed through the use of the deployment system 200 at the base 202 of the deployable mast 114. The deployable mast 114 may have an elongate band 203 wound in a spiral or coiled shape when stowed and then wound helically or helicoidally to form a longitudinally extended cylinder when deployed. The elongate band 203 may be stowed in a storage real 204. A transverse plane may intersect the stowed elongate band 203 and be perpendicular to a direction of deployment of the deployable mast 114. The deployable mast 114 may deploy out of the plane of the stowed elongate band 203. The deployable mast 114 may have a constant diameter along a length of the deployable mast 114 in the deployed configuration.

The deployment system 200 may deploy the elongate band 203 from the stowed configuration into a deployed, helical configuration along a longitudinal axis LA of the deployable mast 114. The deployment system 200 may be configured to feed, e.g., push, slide, or bias, the elongate band 203 helically to form the deployable mast 114 and extend the mast linearly along the longitudinal axis LA of the deployable mast 114. The elongate band 203 may be fed to form the deployable mast 114 with one or more rotating components of the deployment system 200 about the longitudinal axis LA. The elongate band 203 may deploy without rotating a cylindrical, deployed portion of the deployable mast 114 about the longitudinal axis LA. Thus the cylindrical portion of the deployable mast 114 may remain rotationally stationary as it deploys linearly. The deployment of the deployable mast 114 may define a channel 116 extending from the base to a deploying end 115 at a free end of the deployable mast 114. The deployable mast 114 can define an airtight channel 116. In some embodiments, the channel 116 of the deployable mast 114 can be lined with a polytetrafluoroethylene (PTFE) liner or coating.

The deployment system 200 may include a housing 205. The housing 205 may provide support to the deployable mast 114 during and after deployment. The housing 205 may assist in guiding the elongate band 203 to form the deployable mast 114 during the deployment process. The housing 205 may include a stiffener section 206 at a deployment end of the housing 205 (e.g., where the elongate band is fed out of the housing 205). The stiffener section 206 may provide support to the deployable mast 114 as it deploys. The stiffener section 206 may assist in maintaining the intended shape of the deployable mast 114.

The deployment system 200 may be coupled with an underside 210 of the lander 102, as shown in FIGS. 1A and 1B. The deployment system 200 may be coupled to the lander 102, such that the deployment system 200 is positioned above a designated area for excavation of the borehole 108 and the collection of material. A frame 201 (see FIG. 3) of the deployment system 200 may be coupled with or incorporated into the lander 102.

As shown in FIGS. 1A and 1B, the system 100 may include a plurality of jets 120. The plurality of jets 120 may be positioned and supported at the deploying end 115 (free end) of the deployable mast 114. The plurality of jets 120 may move with the deployable mast 114 and into the borehole 108 as the deployable mast 114 deploys into the borehole 108. The plurality of jets 120 may be in fixed positions relative to the deploying end 115. The plurality of jets 120 may rotate and/or pivot about the fixed positions. One or more of the plurality of jets 120 can be oriented to direct, deliver, and/or apply gas in a different direction than another one of the one or more plurality of jets 120. In some examples, the plurality of jets 120 may function similarly as described but be supported at the free end of the deployable tube 110.

The plurality of jets 120 may provide one or more functions. The plurality of jets 120 may assist in the excavation of the borehole 108 as the deployable mast 114 deploys into the borehole 108. The plurality of jets 120 may direct broken-down smaller pieces of material (e.g., lunar regolith) to the reservoir 101. One or more of the plurality of jets 120 may direct the material through the channel 116 of the deployable mast 114 and into the reservoir 101. In some embodiments, the plurality of jets 120 may be orientated to both excavate material and to direct material to the reservoir 101. In some embodiments, sensors may be used to monitor the orientation of the plurality of jets 120 and adjust the orientation as needed for optimal collection of material.

In some embodiments, the plurality of jets 120 and/or the system 100 can incorporate one or more features of any of the systems and methods described in U.S. Pat. No. 11,479,373, issued Oct. 25, 2022, titled SAMPLE COLLECTION SYSTEM FOR INTERPLANETARY VEHICLE, and U.S. Pat. No. 11,827,388, issued Nov. 28, 2023, titled SAMPLE COLLECTION SYSTEM FOR INTERPLANETARY VEHICLE, the entirety of each of which is incorporated by reference herein for all purposes and forms a part of this specification.

In some embodiments, the deployable tube 110 may be coupled with the deploying end 115 of the deployable mast 114. The deployable tube 110 and the deployable mast 114 can deploy simultaneously and at the same rate. The deployable tube 110 can be positioned within the channel 116 of the deployable mast 114. The deployable tube 110 can be positioned along or adjacent a wall of the channel 116. The deployment of the deployable mast 114 can cause the deployment of deployable tube 110. The deployable tube 110 may be rigid, for example a stowed, coiled (e.g., wound) configuration that deploys into a deployed, stiff linear shape, as described. The deployable tube 110 may be a fixed length tube that moves up and down in response to corresponding movement of the deployable mast 114. In some examples, the deployable tube 110 may be flexible, such as a fabric. The deployable tube 110 may passively deploy and retract in response to corresponding deployment and retraction of the deployable mast 114. In some examples, the deployable tube 110 may deploy prior to the deployable mast 114 to begin formation of the borehole.

In some embodiments, the system 100 may include a collection tube 130 coupling the deployable mast 114 and the reservoir 101. The collection tube 130 may be a fixed pipe or conduit. The collection tube 130 can be aligned with the channel 116 of the deployable mast 114 and/or with a channel of the deployable tube 110. In some embodiments, a first end 131 of the collection tube 130 can be positioned at least partially within the base of the deployable mast 114. A second end 132 of the collection tube 130 can be coupled directly or indirectly with the reservoir 101.

In some embodiments, a flow separator 134 can indirectly couple the collection tube 130 and the reservoir 101. The flow separator 134 can separate the gas and the material being collected. The flow separator 134 can allow gas from the plurality of jets 120 to exit the system while the material being collected travels to the reservoir 101. In some embodiments, a valve 133 can open and close a path between the collection tube 130 or the flow separator 134 and the reservoir 101. One or more jets, similar to the jets 120, may be used to direct the material and gas at the flow separator 134.

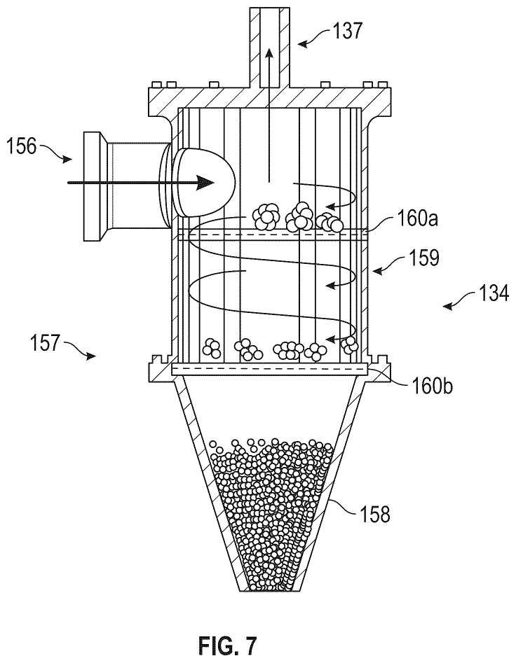

FIG. 7 is a side view of an example flow separator 134 removed from the system 100. The flow separator 134 may be coupled to the collection tube 130 or the deployable mast 114 by a port 156. The port 156 can receive a mix of the high pressure gas and the extracted material. The flow separator 134 may separate the high pressure gas from the extracted material. The flow separator 134 may have a reservoir 157 for collecting extracted material. The reservoir 157 may have a conical region 158 at a base of the flow separator 134. The reservoir 157 may have a cylindrical region 159 between the port 156 and the conical region 158. The extracted material may fall into the reservoir 157 after entering the port 156 of the flow separator 134. The gas and materials may flow in a swirl pattern due to radial placement of the port 156.

In some examples, the flow separator 134 includes one or more filters 160, such as a screen sized to allow passage of the gas but not raw materials. The filters 160 can be mesh screens. The one or more filters 160 may separate the extracted material by size. For example, as shown in FIG. 7, an upper filter 160a may have larger openings than a lower filter 160b. The upper filter 160a may assist in keeping larger sized pieces of material at an upper region of the reservoir 157. The lower filter 160b may assist in keeping medium sized pieces of material in a middle region of the reservoir 157 and allow smaller sized pieces of material to travel to the base or lower region of the reservoir 157.

As shown in FIGS. 1A, 1B, and 7, the flow separator 134 may include a nozzle 137. The nozzle 137 can be an external gas nozzle. The nozzle 137 can be positioned near an upper surface 138 of the lander 102 or system 100. Depending on the size of the borehole 108, pressure used for excavation, location on the lander 102, and mass of the lander 102, the gas exiting the nozzle 137 may provide a downward force to keep the lander 102 balanced and grounded. The nozzle 137 may emit a gas upward to cause a downward thrust applied to the lander 102. The nozzle 137 may counteract upward forces on the lander 102 caused by the excavating jets 120. In some embodiments, gasses exiting through the flow separator 134 may also provide balancing forces.

In some embodiments, the system 100 may include a drill skirt 135, as shown in FIGS. 1A and 1B. The drill skirt 135 may surround the deployable mast 114 on the surface 112 of the material to be excavated or collected. The drill skirt 135 may assist in ensuring that gas and material (for example, lunar regolith) travel up through the deployable mast 114. The drill skirt 135 may prevent gas and material from exiting out along the surface 112 external to the deployable mast 114. The drill skirt 135 may prevent the accidental blasting of nearby elements. The drill skirt 135 may include an opening 136. The opening 136 may define an area for formation of the borehole 108. The opening 136 may receive therethrough the deployable mast 114 and/or the deployable tube 110. The drill skirt 135 can be secured to the surface of the material to be excavated and collected.

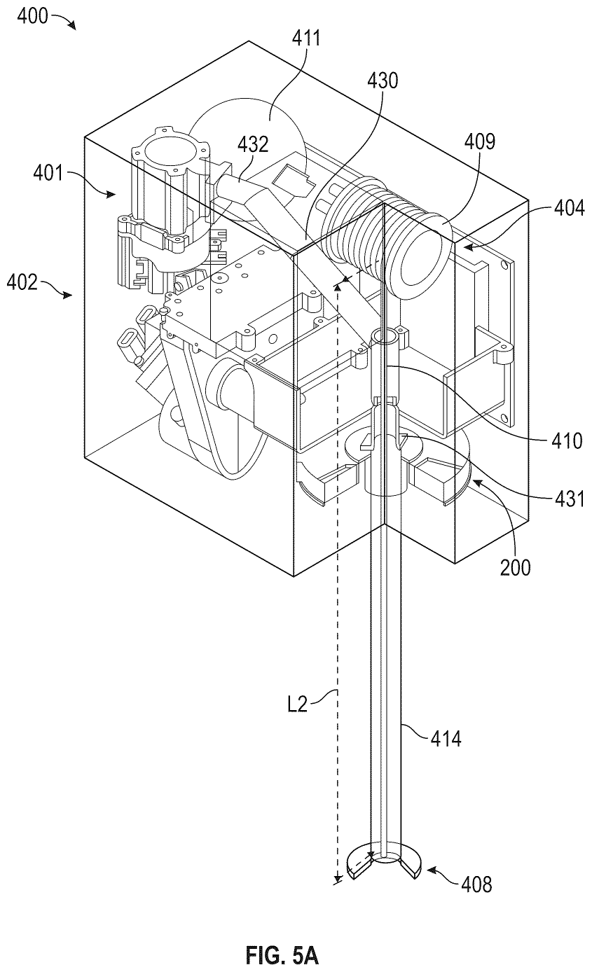

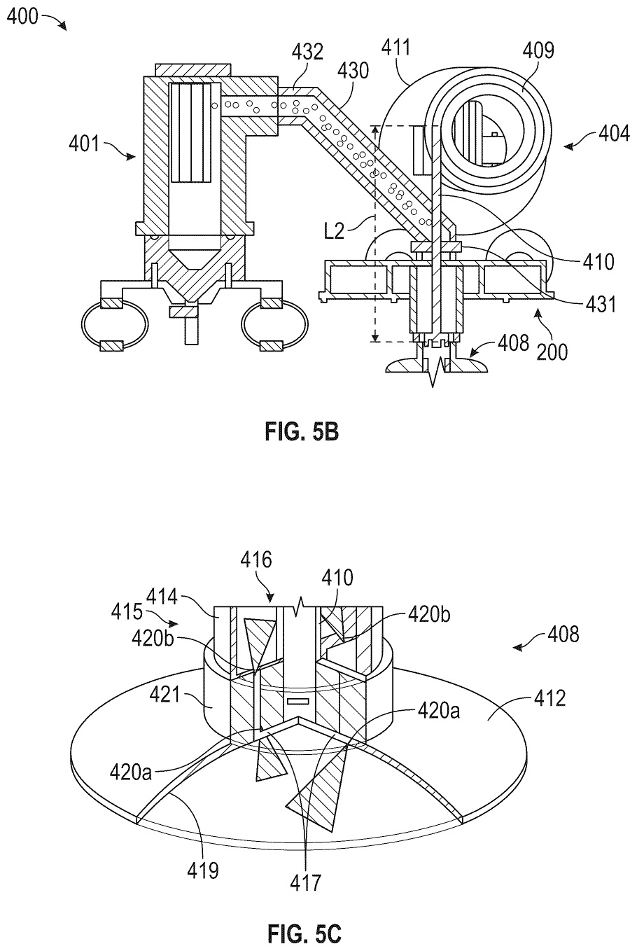

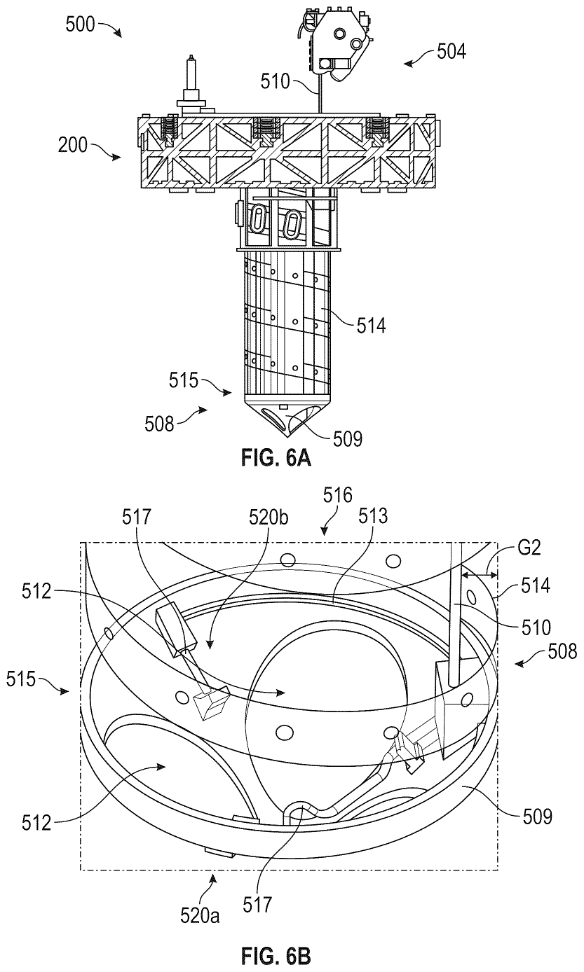

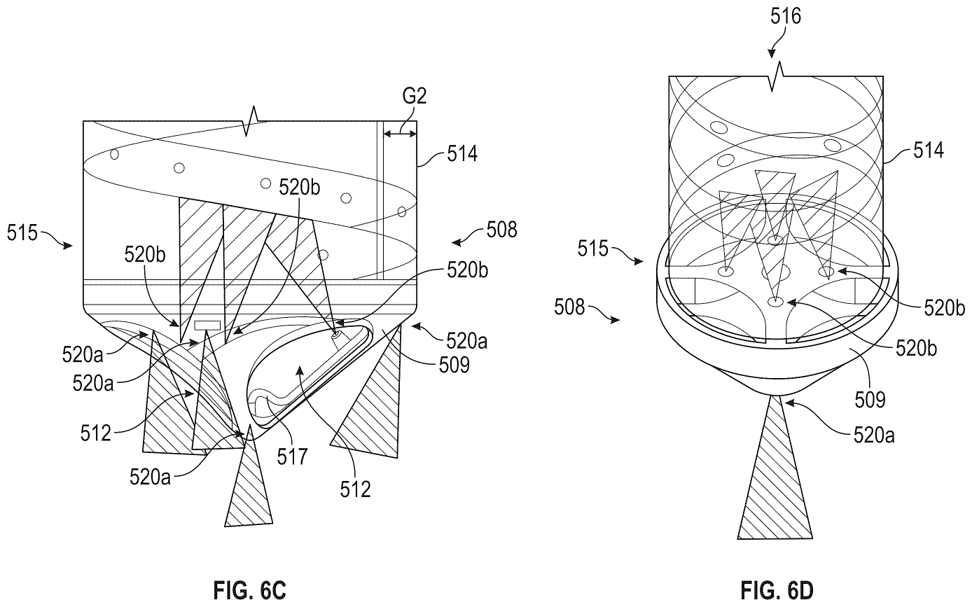

FIG. 4 is a flow chart illustrating an example method 300 for in situ extraction of resources or material (e.g., lunar regolith). The method 300 may be performed by the systems 100, 400, 500 or variations thereof. The method 300 may be used with any of the systems 100 described herein with respect to FIGS. 1A-3 or system 400 described herein with respect to FIGS. 5A-5C or system 500 described herein with respect to FIGS. 6A-6D.

The method 300 may begin at step 302 where a borehole is formed or excavated (e.g., borehole 108). The borehole may be formed by directing, delivering, and/or applying a high pressure gas into a surface of material. The high pressure gas may be applied using an excavation assembly (e.g., excavation assembly 104). The high pressure gas may contact the surface of the material and break the material into smaller pieces, as described with respect to FIGS. 1A-3.

The method 300 may then move to step 304 where a mast (e.g., deployable mast 114 and/or the deployable tube 110) may be deployed into the borehole. In some embodiments, steps 302 and 304 may occur simultaneously. For example, delivery of the high pressure gas and deployment of the mast may occur simultaneously or almost simultaneously. In some embodiments, the initial deployment of the mast may occur prior to the initial formation of the borehole. The mast may be deployed using a deployment system (e.g., deployment system 200). The deployment system may deploy the mast from a stowed configuration to a deployed configuration. The mast in the stowed configuration can be entirely out of the borehole 108. The mast in the deployed configuration can be at least partially within the borehole 108. Any of the associated functions described herein with respect to with respect to FIGS. 1A-3 regarding deploying the mast or tube into the borehole may be employed in step 304.

The method 300 may then move to step 306 wherein material (e.g., lunar regolith) may be directed through a channel (e.g., channel 116) of the mast. The smaller broken-down pieces of material can be directed through the channel of the mast. The material may be directed into a reservoir (e.g., reservoir 101). The material may be directed into the reservoir by applying a force using a plurality of jets. The jets may apply or direct a high pressure gas toward the material. Any of the associated functions described herein with respect to with respect to FIGS. 1A-3 regarding directing the material through the mast and into the reservoir may be employed in step 306.

FIGS. 5A and 5B are perspective and side views of another example system 400 for in situ extraction of resources or material, for example lunar regolith. FIG. 5C is a perspective view of an end of the deployable mast 114 having a jet assembly 408 of the system 400. Embodiments of the system 400 may include any of the features of the systems discussed above or below and should not be limited to the particular embodiments described. For example, features of one embodiment may be combined with features of another embodiment. The particular features shown in FIGS. 5A-5C will now be discussed in detail and features not discussed will be understood to be similar, or identical, to those discussed elsewhere herein. Some or all of the features discussed with respect to FIGS. 5A-5C may be incorporated into the other embodiments described herein.

FIG. 5A illustrates the system 400 in a deployed configuration. FIG. 5B illustrates the system 400 in a stowed configuration. In some embodiments, the system 400 may be coupled with a lander. The system 400 may be assembled within an enclosure 402. The enclosure 402 may be coupled with the lander. The system 400 may be in a stowed configuration as in FIG. 5B for transportation to space or the location where the system 400 will be used as in FIG. 5A. The system 400 may be a pneumatic downhole system used to rapidly excavate a borehole and collect regolith into a reservoir 401 within the enclosure 402.

The system 400 may include an excavation assembly 404. The excavation assembly 404 may be used to form a borehole. The excavation assembly 404 may include a deployable tube 410. In some embodiments, the excavation assembly 404 may include more than one deployable tube 410. A free end of the deployable tube 410 may advance downward to the surface of the material to be excavated. The deployable tube 410 may be a metal tube. The deployable tube 410 may passively deploy in response to deployment of a deployable mast 414, as described herein. The deployable tube 410 may be wound around a reel 409. The deployable tube 410 may be stowed about the reel 409 and passively unwind therefrom as the deployable tube 410 deploys and the reel 409 rotates. As the deployable tube 410 deploys, a length L2 (see FIGS. 5A and 5B) of the deployable tube 410 may increase. In some embodiments, the deployable tube 410 may deploy into an unretractable deployed configuration. In some embodiments, the deployable tube 410 may be retractable following deployment to the stowed configuration. In some examples, the deployable tube 410 may deploy similarly as described with respect to the deployable mast from a coiled (e.g., wound) stowed configuration to a deployed linear configuration. The deployable tube 410 may be stowed in a coil or spiral configuration and deploy into a linear configuration.

In some embodiments, the deployable tube 410 may extend along a central axis of the deployable mast 414, or radially offset therefrom. There may be multiple deployable tubes 410. The deployable tube 410 may be positioned centrally within the deployable mast 414. The deployable tube 410 and the deployable mast 414 may share a common central axis. The deployable mast 414 may have a greater diameter than the deployable tube 410 such that there is a gap between an outer surface of the deployable tube 410 and an inner surface of the deployable mast 414. The material being excavated can travel through the gap between the outer surface of the deployable tube 410 and the inner surface of the deployable mast 414.

The deployable tube 410 may direct, apply, and/or deliver a high pressure gas into a surface to form the borehole. The deployable tube 410 may be coupled with a gas storage tank or gas supply 411. The gas supply 411 may be positioned within the enclosure 402. The surface may be a land surface or ground surface on Earth or another celestial body, such as the moon, Mars, etc. The surface may include raw materials. Example raw materials include but are not limited to lunar regolith, frozen water, minerals, ore, metallic ores, soils, rocks, and water ice. The high pressure gas may break up the material as the high pressure gas contacts the surface. The high pressure gas may be activated as the deployable tube 410 is deployed. In some embodiments, the deployable tube 410 may pause or stop deploying prior to activation of the high pressure gas. The excavation assembly 404 may rapidly excavate the borehole.

The excavation assembly 404 may be used to excavate or form boreholes of any depth and diameter. The depth and diameter of the boreholes may be dependent upon the amount or volume of material to be collected. A depth of the borehole may be at least 1 meter, at least 2 meters, at least 3 meters, at least 4 meters, at least 5 meters, at least 6 meters, or more. A diameter of the borehole may be at least 70 mm, at least 80 mm, at least 90 mm, at least 100 mm, at least 110 mm, at least 120 mm, at least 130 mm, or more. There may be a balance between a pneumatic force at the drill or excavation area and a drill depth. In one non-limiting example, a 152.4 mm (6 inch) borehole may drill or excavate 14 meter deep below the surface 112 to collect 1 meter 3 (min 1100 kg depending on regolith density) of material, whereas to collect the same volume, a 203.2 mm (8 inch) bore may only need to drill or excavate 8 meters deep.

The system 400 may include a deployable mast 414. The deployable mast 414 may deploy into the borehole from a stowed configuration to a deployed configuration. The deployable mast 414 may deploy from a stowed configuration within the enclosure 402 to a deployed configuration at least partially outside of the enclosure 402. The deployment of the deployable mast 414 and the excavation of the borehole may occur simultaneously. The deployable mast 414 may include any of the features of any of the deployable masts and/or utilize any features of the methods of deployment of such masts as described in U.S. application Ser. No. 19/092785, titled SYSTEMS AND METHODS FOR WELDED DEPLOYABLE LINEAR STRUCTURES, filed on Mar. 27, 2025, U.S. application Ser. No. 19/093044, titled SYSTEMS AND METHODS FOR DEPLOYABLE LINEAR STRUCTURES WITH DOUBLERS, filed on Mar. 27, 2025, U.S. application Ser. No. 19/092758, titled SYSTEMS AND METHODS FOR SPACE HABITATS USING DEPLOYABLE LINEAR STRUCTURES, filed on Mar. 27, 2025, U.S. application Ser. No. 19/092767, titled SYSTEMS AND METHODS FOR DEPLOYABLE LINEAR STRUCTURES WITH RIVETS, filed on Mar. 27, 2025, U.S Provisional Application No. 63/701002, titled SYSTEMS AND METHODS FOR DEPLOYABLE LINEAR STRUCTURES WITH WELDING, DOUBLERS, AND/OR RIVETS, filed Sep. 30, 2024, and U.S. Provisional Application No. 63/57142, titled DEPLOYABLE INTERLOCKING ACTUATED BANDS FOR LINEAR OPERATIONS, filed Mar. 28, 2024, the entirety of each of which is incorporated by reference herein for all purposes and forms a part of this specification.

In some embodiments, the deployable mast 414 may be deployed using the deployment system 200, for example as shown in FIGS. 3, 5A, and 5B. The deployment system 200 may be positioned within the enclosure 402 as shown in FIGS. 5A and 5B.

As shown in FIG. 5C, the system 400 may include the jet assembly 408. The jet assembly 408 may include a shield 412 and/or a plurality of jets 420. The shield 412 may function as a drill skirt during the initial excavation of the borehole. The plurality of jets 420 may be coupled with or integrated with or near the shield 412 during initial deployment of the deployable mast 414. In some embodiments, gas tubes 417 of the plurality of jets may extend within the walls of the shield 412. The gas tubes 417 may be fluidically coupled with the deployable tube 410. The deployable tube 410 may direct the high-pressure gas to the jet assembly 408. In some examples, the deployable tube 410 may extend all the way to the jets 420, such that the gas tubes 417 are not needed or are extensions or sections of the deployable tube 410.

The jet assembly 408 may be positioned and supported at the deploying end 415 (e.g., free end) of the deployable mast 414. The jet assembly 408 may move with the deployable mast 414 and into the borehole as the deployable mast 414 deploys into the borehole. The plurality of jets 420 may be in fixed positions relative to the deploying end 415. The plurality of jets 420 may rotate and/or pivot about the fixed positions. One or more of the plurality of jets 420 can be oriented to direct, deliver, and/or apply gas in a different direction than another one of the one or more plurality of jets 120.

The plurality of jets 120 may provide one or more functions. The plurality of jets 420 may be orientated to both excavate material and to direct material to the reservoir 401. The jet assembly 408 may include one or more jets 420a positioned to face downward toward and/or into the borehole. The jets 420 a may direct gas out of an underside 419 of the shield 412 in a downward direction. The jets 420a may assist in the excavation of the borehole as the deployable mast 414 deploys into the borehole. The jet assembly 408 may include one or more jets 420b positioned to face upward and/or into a channel 416 of the deployable mast 414. The jets 420b may direct gas upward and direct broken-down smaller pieces of material (e.g., lunar regolith) to the reservoir 401. One or more of the jets 420b may direct the material through the channel 416 of the deployable mast 414 and into the reservoir 401. In some embodiments, sensors may be used to monitor the orientation of the plurality of jets 420 and adjust the orientation as needed for optimal collection of material.

In some embodiments, the deployable tube 410 may be coupled with the deploying end 415 of the deployable mast 414. The deployable tube 410 may be coupled with the deploying end 415 of the deployable mast 414 via a connecting end 421 of the shield 412. The deployable tube 410 and the deployable mast 414 can deploy simultaneously and at the same rate. The deployment of the deployable mast 414 can cause the deployment of deploy able tube 410. The deployable tube 410 may be rigid, for example a stowed, coiled (e.g., wound) configuration that deploys into a deployed, stiff linear shape, as described. The deployable tube 410 may be a fixed length tube that moves up and down in response to corresponding movement of the deployable mast 414. In some examples, the deployable tube 410 may be flexible, such as a fabric. The deployable tube 410 may passively deploy and retract in response to corresponding deployment and retraction of the deployable mast 414. The deployable tube 410 may be wound on a reel and unfurled to extend in length, as described with respect to FIGS. 5A and 5B. The deployable tube 410 may flow gasses to the jets 120. There may be multiple deployable tubes 410.

In some embodiments, the system 400 may include a collection tube 430 coupling the deployable mast 414 and the reservoir 401, as shown in FIGS. 5A and 5B. The collection tube 430 may be a fixed pipe or conduit. The collection tube 430 can be aligned with the channel 416 (see FIG. 5C) of the deployable mast 414 and/or with a channel of the deployable tube 410. In some embodiments, a first end 431 of the collection tube 430 can be coupled with a surface of the deployment system 200. A second end 432 of the collection tube 430 can be coupled directly or indirectly with the reservoir 401.

FIG. 6A is a side view of an example system 500 for in situ extraction of resources or material, for example lunar regolith. FIG. 6A illustrates the system 500 in a deployed configuration. FIGS. 6B-6D illustrate various views of a jet assembly 508 of the system 500. Embodiments of the system 500 may include any of the features of the systems discussed above or below and should not be limited to the particular embodiments described. For example, features of one embodiment may be combined with features of another embodiment. The particular features shown in FIGS. 6A-6D will now be discussed in detail and features not discussed will be understood to be similar, or identical, to those discussed elsewhere herein. Some or all of the features discussed with respect to FIGS. 6A-6D may be incorporated into the other embodiments described herein.

In some embodiments, the system 500 may be coupled with a lander and/or disposed within an enclosure. The system 500 may be in a stowed configuration for transportation to space or the location where the system 500 will be used. The system 500 may be a pneumatic downhole system used to rapidly excavate a borehole and collect regolith into a reservoir.

The system 500 may include an excavation assembly 504. The excavation assembly 504 may be used to form a borehole. The excavation assembly 504 may include a deployable tube 510, which may have the same or similar features or functions as other deployable tubes herein. In some embodiments, the excavation assembly 504 may include more than one deployable tube 510. A free end of the deployable tube 510 may advance downward to the surface of the material to be extracted. The deployable tube 510 may be a metal tube. The deployable tube 510 may passively deploy in response to deployment of a deployable mast 514, as described herein. In some examples, the deployable tube 510 may deploy similarly as described with respect to the deployable mast from a coiled (e.g., wound) stowed configuration to a deployed linear configuration. The deployable tube 510 may be stowed in a coil configuration and deploy into a linear configuration. The deployable tube 510 may be stowed about a reel. As the deployable tube 510 deploys, a length of the deployable tube 510 may increase. In some embodiments, the deployable tube 510 may deploy into an unretractable deployed configuration. In some embodiments, the deployable tube 510 may be retractable following deployment to the stowed configuration.

In some embodiments, the deployable tube 510 may extend along or adjacent an inner surface of the deployable mast 514, which may have the same or similar features or functions as other deployable masts described herein. The deployable tube 510 may be positioned offset from a central axis of the deployable mast 514. The deployable tube 510 and the deployable mast 514 may have different central axes. There may be a gap G2 (as shown in FIG. 6B or 6D) between the inner surface of the deployable mast 514 and an outer surface of the deployable tube 510.

The deployable tube 510 may direct, apply, and/or deliver a high pressure gas into a surface to form the borehole. The deployable tube 510 may be coupled with a gas storage tank or gas supply. The gas supply may be coupled to the lander. The surface may be a land surface or ground surface on Earth or another celestial body, such as the moon, Mars, etc. The surface may include raw materials. Example raw materials include but are not limited to lunar regolith, frozen water, minerals, ore, metallic ores, soils, rocks, and water ice. The high pressure gas may break up the material as the high pressure gas contacts the surface. The high pressure gas may be activated as the deployable tube 510 is deployed. In some embodiments, the deployable tube 510 may pause or stop deploying prior to activation of the high pressure gas. The excavation assembly 504 may rapidly excavate the borehole.

The excavation assembly 504 may be used to excavate or form boreholes of any depth and diameter. The depth and diameter of the boreholes may be dependent upon the amount or volume of material to be collected. A depth of the borehole may be at least 1 meter, at least 2 meters, at least 3 meters, at least 4 meters, at least 5 meters, at least 6 meters, or more. A diameter of the borehole may be at least 70 mm, at least 80 mm, at least 90 mm, at least 100 mm, at least 110 mm, at least 120 mm, at least 130 mm, or more. There may be a balance between a pneumatic force at the drill or excavation area and a drill depth. In one non-limiting example, a 152.4 mm (6 inch) borehole may drill or excavate 14 meter deep below the surface to collect 1 meter 3 (min 1100 kg depending on regolith density) of material, whereas to collect the same volume, a 203.2 mm (8 inch) bore may only need to drill or excavate 8 meters deep.

The system 500 may include the deployable mast 514. The deployable mast 514 may deploy into the borehole from a stowed configuration to a deployed configuration. The deployment of the deployable mast 514 and the excavation of the borehole may occur simultaneously. The deployable mast 514 may include any of the features of any of the deployable masts and/or utilize any features of the methods of deployment of such masts as described in U.S. application Ser. No. 19/092785, titled SYSTEMS AND METHODS FOR WELDED DEPLOYABLE LINEAR STRUCTURES, filed on Mar. 27, 2025, U.S. Application No. 19/093044, titled SYSTEMS AND METHODS FOR DEPLOYABLE LINEAR STRUCTURES WITH DOUBLERS, filed on Mar. 27, 2025, U.S. application Ser. No. 19/092758, titled SYSTEMS AND METHODS FOR SPACE HABITATS USING DEPLOYABLE LINEAR STRUCTURES, filed on Mar. 27, 2025, U.S. application Ser. No. 19/092767, titled SYSTEMS AND METHODS FOR DEPLOYABLE LINEAR STRUCTURES WITH RIVETS, filed on Mar. 27, 2025, U.S Provisional Application No. 63/701002, titled SYSTEMS AND METHODS FOR DEPLOYABLE LINEAR STRUCTURES WITH WELDING, DOUBLERS, AND/OR RIVETS, filed Sep. 30, 2024, and U.S. Provisional Application No. 63/57142, titled DEPLOYABLE INTERLOCKING ACTUATED BANDS FOR LINEAR OPERATIONS, filed Mar. 28, 2024, the entirety of each of which is incorporated by reference herein for all purposes and forms a part of this specification. In some embodiments, the deployable mast 514 may be deployed using the deployment system 200, for example as shown in FIGS. 3, 5A, 5B, and 6A.

As shown in FIGS. 6B-6D, the system 500 may include a jet assembly 508, which may have the same or similar features or functions as any other jet assembly described herein. The jet assembly 508 may include a plurality of jets 520, which may have the same or similar features or functions as any other jets described herein. The jet assembly 508 may be fluidically coupled with the deployable tube 510. The deployable tube 510 may direct the high-pressure gas to the jet assembly 508. The jet assembly 508 may include a gas manifold 513. The gas manifold 513 can be in fluid communication with gas tubes 517. The gas tubes 517 can couple the gas manifold 513 with the plurality of jets 520.

In some embodiments, the deployable tube 510 and/or the jet assembly 508 may be coupled with the deploying end 515 of the deployable mast 514. The deployable tube 510 and the deployable mast 514 can deploy simultaneously and at the same rate. The deployable tube 510 can be positioned within the channel 516 of the deployable mast 514. The deployable tube 510 can be positioned along or adjacent a wall of the channel 516. The deployment of the deployable mast 514 can cause the deployment of deployable tube 510. The deployable tube 510 may be rigid, for example a stowed, coiled (e.g., wound) configuration that deploys into a deployed, stiff linear shape, as described. The deployable tube 510 may be a fixed length tube that moves up and down in response to corresponding movement of the deployable mast 514. In some examples, the deployable tube 510 may be flexible, such as a fabric. The deployable tube 510 may passively deploy and retract in response to corresponding deployment and retraction of the deployable mast 514. In some examples, the deployable tube 510 may deploy prior to the deployable mast 514 to begin formation of the borehole.

The jet assembly 508 may be positioned and supported at the deploying end 515 (e.g., free end) of the deployable mast 514. The jet assembly 508 may move with the deployable mast 514 and into the borehole as the deployable mast 514 deploys into the borehole. The plurality of jets 520 may be in fixed positions relative to the deploying end 515. The plurality of jets 520 may rotate and/or pivot about the fixed positions. One or more of the plurality of jets 520 can be oriented to direct, deliver, and/or apply gas in a different direction than another one of the one or more plurality of jets 520. In some examples, the plurality of jets 520 may function similarly as described but be supported at the free end of the deployable tube 510.

The jet assembly 508 may be coupled with the deploying end 515 of the deployable mast 514 by a support 509. The support 509 can be positioned around an outer surface of the deploying end 515 of the deployable mast 514. The support 509 may have a conical shape. The plurality of jets 520 may be coupled to inner and outer surfaces of the support 509. The support 509 may include a plurality of openings 512. The plurality of openings 512 may be circumferentially spaced about the support 509. Material being excavated can travel through the openings 512 and into the channel 516 of the deployable mast 514. There may be one two, three, four, five or more of the openings 512. The openings 512 may be separated by structural ribs. The openings 512 may be elongated slots. The openings 512 may be angled corresponding to a contour of the support 509 or deploying end 515.

The plurality of jets 520 may provide one or more functions. The plurality of jets 520 may be orientated to both excavate material and to direct material to the reservoir. The jet assembly 508 may include one or more jets 520a positioned to face downward toward and/or into the borehole. The jets 520a may be positioned on an outer surface of the support 509. The jets 520a may assist in the excavation of the borehole as the deployable mast 514 deploys into the borehole. The jet assembly 508 may include one or more jets 520b positioned to face upward and/or into a channel 516 of the deployable mast 514. The jets 520b may be positioned on an inner surface of the support 509. The jets 520b may direct broken-down smaller pieces of material (e.g., lunar regolith) to the reservoir. One or more of the jets 520b may direct the material through the channel 516 of the deployable mast 514 and into the reservoir. In some embodiments, sensors may be used to monitor the orientation of the plurality of jets 520 and adjust the orientation as needed for optimal collection of material.

The systems and methods described herein are advantageous in part due to the rapid speed of collection of material. For example, the systems and methods according to the present disclosure can excavate and collect the desired amount of material within a couple of hours. In contrast, traditional systems and methods can take multiple days to excavate and collect the desired amount of material.

Various modifications to the implementations described in this disclosure will be readily apparent to those skilled in the art, and the generic principles defined herein may be applied to other implementations without departing from the spirit or scope of this disclosure. Thus, the disclosure is not intended to be limited to the implementations shown herein but is to be accorded the widest scope consistent with the claims, the principles and the novel features disclosed herein. The word “example” or “embodiment” is used exclusively herein to mean “serving as an example, instance, or illustration.” Any implementation described herein as “example” or “embodiment” is not necessarily to be construed as preferred or advantageous over other implementations, unless otherwise stated.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Additionally, other implementations are within the scope of the following claims. In some cases, the actions recited in the claims may be performed in a different order and still achieve desirable results.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1-20. (canceled)

21. A system for in situ extraction of a material, the system comprising:
a deployable mast configured to deploy into a borehole from a stowed configuration to a deployed configuration; and
a jet assembly supported at a free end of the deployable mast, the jet assembly configured to move with the deployable mast and direct a high pressure gas into the borehole, the jet assembly comprising:
a first plurality of jets configured to face toward or into the borehole and assist in excavation of the borehole, and
a second plurality of jets configured to face upward and into a channel of the deployable mast and direct broken-down material through the channel and into a reservoir.

22. The system of claim 21 further comprising a deployable tube configured to direct the high pressure gas into the material to form the borehole.

23. The system of claim 22, wherein the jet assembly is fluidically coupled with the deployable tube.

24. The system of claim 21, wherein each of the first plurality of jets are in a fixed position relative to the free end of the deployable mast, and wherein each of the first plurality of jets are configured to rotate or pivot about the fixed position.

25. The system of claim 21 further comprising a flow separator coupled with the deployable mast, the flow separator configured to separate the high pressure gas from the broken-down material.

26. The system of claim 25, wherein the flow separator comprises a plurality of filters configured to separate the broken-down material by size.

27. The system of claim 25, wherein the flow separator comprises a nozzle configured to emit gas to counteract upward forces applied to the system by the jet assembly.

28. A system for in situ extraction of a material, the system comprising:
a deployable mast configured to deploy into a borehole from a stowed configuration to a deployed configuration; and
a jet assembly configured to move with a free end of the deployable mast and configured to direct a high pressure gas into the borehole, the jet assembly comprising:
a support configured to couple the jet assembly to the free end of the deployable mast, the support comprising a plurality of openings, and
a plurality of jets coupled to the support and configured to direct broken-down material through the plurality of openings of the support and into a channel of the deployable mast.

29. The system of claim 28, further comprising a deployable tube configured to direct the high pressure gas into the material to form the borehole, the deployable tube configured to passively deploy in response to deployment of the deployable mast.

30. The system of claim 29, wherein the deployable tube is wound around a reel and configured to passively unwind therefrom as the deployable tube deploys and the reel rotates.

31. The system of claim 28, wherein the support comprises a conical shape.

32. The system of claim 28, wherein the plurality of openings are circumferentially spaced about the support.

33. The system of claim 28, wherein the plurality of jets comprises one or more jets coupled to an inner surface of the support and one or more jets coupled to an outer surface of the support.

34. The system of claim 28, wherein at least one of the plurality of openings is an elongate slot.

35. The system of claim 28, wherein the plurality of openings are separated by structural ribs.

36. A system for in situ extraction of a material, the system comprising:
a deployable tube configured to direct a high pressure gas into a borehole;
a deployable mast configured to deploy into the borehole from a stowed configuration to a deployed configuration; and
a jet assembly fluidically coupled with the deployable tube, the jet assembly configured to assist in excavation of the borehole and direct broken-down material through a channel of the deployable mast and into a reservoir.

37. The system of claim 36 further comprising a manifold, the deployable tube and the jet assembly fluidically coupled by the manifold.

38. The system of claim 36, wherein the deployable tube is configured to passively deploy in response to deployment of the deployable mast, the deployable tube being wound around a reel and configured to passively unwind therefrom as the deployable tube deploys and the reel rotates.

39. The system of claim 36 further comprising a flow separator coupled with the deployable mast, the flow separator configured to separate the high pressure gas from the broken-down material.

40. The system of claim 39, wherein the flow separator comprises a plurality of filters configured to separate the broken-down material by size.
